(19) United States
(12) Patent Application Publication
(10) Pub. No.: US 2021/0192318 A1
(43) Pub. Date: Jun. 24, 2021

(54) SYSTEM AND METHOD FOR TRAINING DEEP-LEARNING CLASSIFIERS

(71) Applicant: DTS, Inc., Calabasas, CA (US)

(72) Inventor: Michael M. GOODWIN, Scotts Valley, CA (US)

(73) Assignee: DTS, Inc., Calabasas, CA (US)

(21) Appl. No.: 17/131,577

(22) Filed: Dec. 22, 2020

Related U.S. Application Data
(60) Provisional application No. 62/952,948, filed on Dec. 23, 2019.

(51) Int. Cl. G06N 3/04; G06N 3/08

(52) U.S. Cl. CPC G06N 3/04; G06N 3/08

(57) ABSTRACT

Deep-learning classifier training systems and methods for training a classification system based on machine learning are disclosed. In some embodiments the training is configured to form classification regions of a specified shape. In some embodiments the training is configured to form classification regions in accordance with specified classification criteria. The systems and methods disclosed for training a classification system lead to improved inference performance.

### RELATED APPLICATION AND PRIORITY CLAIM

This application is related to and claims priority to U.S. Provisional Application No. 62/952,948, filed on Dec. 23, 2019 and titled “Discriminative Training for Deep Classification ,” which is hereby incorporated by reference in its entirety.

### BACKGROUND

Classification generally refers to the process of organizing a set of examples into groups, with certain characteristics shared within a group and different between different groups. For instance, in a common musical instrument classification system, an instrument may be classified as a string instrument, a brass instrument, a woodwind instrument, or a percussion instrument. Each class is defined by one or more properties shared between its members. For instance, a vibrating string is the mechanism of sound production in string instruments. To categorize a previously unclassified new instrument, the properties of the new instrument are considered in light of the class definitions. The new instrument is assigned to the class whose defining properties are the closest match to its own. This example illustrates that classification involves two aspects, that of establishing or defining the various classes and that of assigning new examples to the established classes.

As in the example discussed above, classification can be based on qualitative considerations. Classification can also be framed quantitatively, in which case classes and examples are represented mathematically. For instance, a number of classes may be established or defined as corresponding respectively to distinct regions in a mathematical space. Thus, a new example may be assigned to a particular class if its mathematical representation lies within the boundaries of that class's region. Typically, the establishment of mathematical definitions of classes is based on analysis of a set of examples whose respective classes are known a priori, which are commonly referred to as labeled examples. The process of analyzing a set of labeled examples to determine a mathematical class structure is known as classifier training, and the set of labeled examples used for this purpose is commonly referred to as a training set. Once classes are defined, an unlabeled example, in other words an example with an unknown class, can be assigned a class based on mathematical analysis. The process of analyzing an unlabeled example to determine a classification for the example is known as inference.

Classifier training is typically based on two objectives: intra-class compaction and inter-class spread. In other words, the classifier is trained such that (1) the mathematical representations of examples of a given class are clustered together in the mathematical space, and (2) distinct classes are spaced apart from each other in the mathematical space. Often, the classifier training involves deriving a transformation that maps an initial mathematical space in which examples are initially represented (a raw feature space) into a new mathematical space (a conditioned feature space) wherein intra-class compaction and inter-class spread are improved with respect to the initial space. Typically, after training is completed the conditioned feature space is analyzed or experimented with to determine classification rules based on certain criteria, for instance classification error rates. Inference can then be carried out based on these determined classification rules.

As explained above, current classifiers use separate processes for classifier training and determine of classification rules for inference. The feature-space conditioning, however, may be suboptimal for inference using the determined classification rules.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the deep-learning classifier training system and method provide an improved approach wherein classifier training is specifically based on classification rules. In other words, the rules for inference are incorporated in the feature-space conditioning transformation derived by the training process. In embodiments based on deep learning, novel objective functions are constructed based on inference rules and the feature-space transformation is learned via backpropagation. Embodiments of the system and method exhibit improved classification performance with respect to several other existing approaches.

Classification systems based on machine learning are in growing use, for instance in face recognition, speaker identification, fingerprint authentication, and many other applications. In such systems, training involves providing the classifier with sets of input examples from established classes, for instance a number of facial photographs of each of several people in a facial recognition system wherein each person corresponds to a class and photographs of the same person comprise examples of that person's class. Training a machine-learning classifier involves forming mathematical representations of the input examples in terms of quantitative features estimated from the examples. These representations are commonly referred to as feature vectors or sometimes as raw feature vectors. The machine-learning system is trained to map the feature vectors of the input examples into new mathematical representations, often referred to as embeddings (which in turn are elements of an embedding space) or sometimes as conditioned feature vectors, such that embeddings corresponding to each established class are clustered together in the embedding space and such that different classes are separated in the embedding space. These training targets may be referred to as intra-class compaction, meaning the elements of each established class are tightly clustered in the embedding space, and inter-class spread, meaning the various established classes are separated from each other in the embedding space. If these targets are achieved in training, then in inference, if an example with an unknown class (an unlabeled example) is presented to the classifier, the classifier can estimate to which class (if any) the example belongs based on proximity metrics in the embedding space, for instance. In other words, the unknown example can be assigned to the class to which it is closest in the embedding space.

Embodiments of the deep-learning classifier training system and method disclosed herein use novel techniques and objective functions to train a deep-learning classification system to condition the feature space in accordance with classification criteria, in other words to derive an embedding space in accordance with classification criteria. Existing approaches often use other training objectives to condition the feature space to generally group examples from the same class together in feature space (intra-class compaction) while enforcing inter-class separation but have not attempted to form classes based on specific classification criteria. Embodiments of the deep-learning classifier training system and method afford specific control over class formation and structure and in some cases remove the need to carry out a search for classification criteria as is required in existing approaches.

For the purposes of summarizing the disclosure, certain aspects, advantages, and novel features of the inventions have been described herein. It is to be understood that not necessarily all such advantages can be achieved in accordance with any particular embodiment of the inventions disclosed herein. Thus, the inventions disclosed herein can be embodied or carried out in a manner that achieves or optimizes one advantage or group of advantages as taught herein without necessarily achieving other advantages as can be taught or suggested herein.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### BRIEF DESCRIPTION OF THE DRAWINGS

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

FIG. 1 depicts a block diagram illustrating an example of a classification inference system that can be used with embodiments of the deep-learning classifier training system and method.

FIG. 2 is a flow diagram of a classification inference process in accordance with embodiments of the deep-learning classifier training system and method disclosed herein.

FIG. 3 depicts a block diagram of a classification training system in accordance with embodiments of the deep-learning classifier training system and method.

FIG. 4 is a flow diagram illustrating the classification training process in accordance with embodiments of the deep-learning classifier training method.

FIG. 5A is a depiction of labeled examples in a raw feature space according to some embodiments of the system and method.

FIG. 5B is a depiction of labeled examples in a conditioned feature space according to some embodiments of the system and method.

FIG. 6 is a depiction of labeled examples and arbitrarily shaped classification regions in a feature space.

FIG. 7 is a depiction of labeled examples and circular classification regions in a feature space.

FIG. 8 depicts plots of cost functions for in-class and out-of-class examples in accordance with embodiments of the system and method.

FIG. 9 is a plot of per-example cost functions in accordance with embodiments of the system and method.

### DETAILED DESCRIPTION

As described above in the Background and Summary, automated classification has a wide range of applications including biometric identity authentication using facial images, speech samples, or fingerprints. Robust classifier performance depends on generating a feature-space transformation which can map from raw sensor measurements and feature estimates to an embedding space wherein the classes of interest can be readily discriminated. In other words, in the embedding space, examples from the same class are clustered together while distinct classes are spread apart. In addition to a feature-space transformation, automated classification of unlabeled examples requires the application of classification criteria in an inference process to determine to which class, if any, an unlabeled example belongs.

Existing approaches derive a feature-space transformation based on the general objective of improving class discriminability via intra-class compaction and inter-class spread; classification criteria for inference are then determined subsequent to deriving the feature-space transformation. This can be implemented, for example, by experimenting with a range of classification criteria on a test set. Embodiments of the system and method described herein include novel objective functions in a classifier training process that are used to derive feature-space transformations based on explicit classification criteria incorporated in the training objectives. This serves to remove the need for experimentation to determine inference rules and improving the performance with respect to existing approaches.

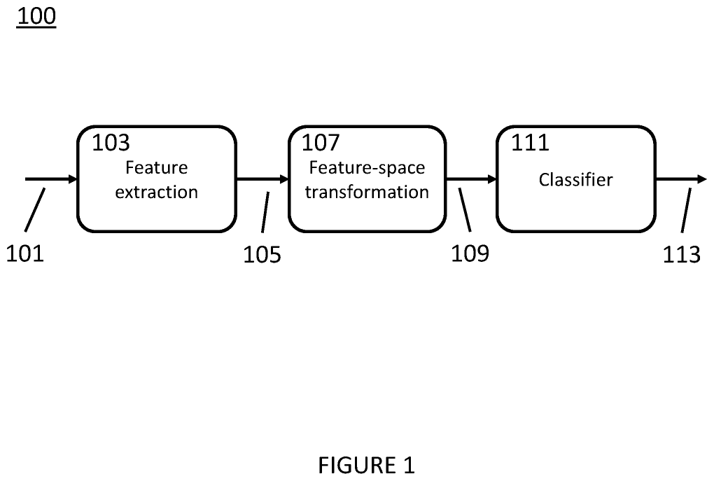

FIG. 1 depicts a block diagram illustrating an example of a classification inference system 100 that can be used with embodiments of the deep-learning classifier training system and method. The classification inference system 100 receives an input on line 101. The input comprises a signal. In some embodiments, the input includes a digital audio waveform signal which includes a speech signal component. In other embodiments, the input includes an image signal that may include a human face as part of the image.

A feature extraction unit 103 receives the input on line 101 and generates an unlabeled example feature vector. The example feature vector is a mathematical representation of the input provided on line 101. The example feature vector is unlabeled in that it does not have a known class. The unlabeled example feature vector is provided as an output by feature example block 103 on line 105. The unlabeled example feature vector can be interpreted as a vector in a feature space.

A feature-space transformation unit 107 receives the unlabeled example feature vector as input on line 105. The feature-space transformation unit 107 carries out mathematical operations on the input example feature vector provided on line 105 to generate an output example vector in a different feature space than that of the input feature vector. In some embodiments, the input to a feature transformation process is referred to as a raw feature vector. In some embodiments the vector space to which the example feature vector belongs is referred to as a feature space or a raw feature space. In some embodiments, the feature-space transformation processing is referred to as feature-space conditioning. In some embodiments, the output example vector is referred to as an embedding. The corresponding feature space of the output example vector can also be referred to as an embedding space or a conditioned feature space.

The embedding generated by feature-space transformation unit 107 is provided as output on line 109 and received by a classifier unit 111. The classifier unit 111 analyzes the embedding to determine whether or not the embedding belongs to one of a set of one or more established classes. The classifier unit 111 provides a classification determination as output on line 113. In some embodiments the determination is a label corresponding to an established class to which the embedding is deemed to belong. The determination is an indication that the embedding does not belong to any of the set of established classes. In some embodiments, the set of established classes considered in classifier unit 111 as potential class assignments for input embeddings may be a subset of the sets of labeled classes used to determine the feature-space transformation unit 107. In some embodiments, the set of established classes used in classifier unit 111 as potential class assignments for input embeddings may be distinct from the set of classes used to determine the feature-space transformation unit 107. For instance, in a speaker authentication system, the feature-space transformation unit 107 may be configured for classification of example embeddings of distinct individual speakers based on a training set of speech samples labeled with speaker identities, where each speaker identity corresponds to a class. The classifier unit 111 may be configured for classification of input embeddings with respect to a set of speaker identities not included in the training set, for instance a set of speaker identities collected in an enrollment process for the speaker authentication system.

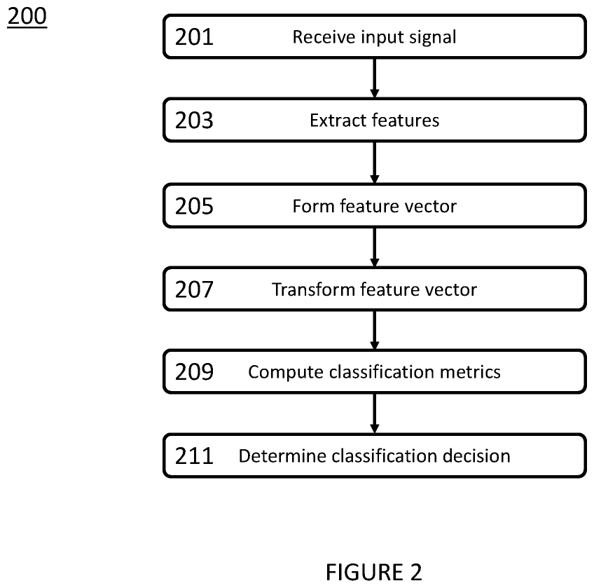

FIG. 2 is a flow diagram of a classification inference process 200 in accordance with embodiments of the deep-learning classifier training system and method disclosed herein. The classification inference process 200 begins with receiving an input signal (box 201). It should be noted that in some embodiments multiple feature vectors are received from one input signal. For instance, if a long clip of speech is provided for authentication, several embeddings can be generated. Next, the classification inference process extracts features from the input signal (box 203).

The process 200 then aggregates the extracted features into a feature vector (box 205). The aggregation also includes scaling the elements of the feature vector. In some embodiments the aggregation also includes normalizing the feature vector. It should be noted that in some embodiments boxes 201, 203 and 205 correspond to operations carried out in the feature extraction unit 103 of the classification inference system 100.

Mathematically, the feature vector formed by the aggregation in box 205 can be represented in mathematical vector notation as \vec{x}. Denoting the number of real-valued features aggregated into feature vector \vec{x} as P, \vec{x} is a real-valued P-dimensional vector or, in mathematical notation, \vec{x}∈ [symbol] ^{P}. With this notation, the raw feature space is [symbol] ^{P}. Subsequently, for the sake of notational simplicity, vector notation will be omitted from vector variables. As will be understood by those of ordinary skill in the art, either a textual definition or a relationship such as x∈ [symbol] ^{P} is sufficient to establish that x is a vector.

The classification inference process 200 continues by mapping the feature vector formed in box 205 into a new Q-dimensional real-valued feature space, which may be referred to as an embedding space (box 207). The transformed feature vector may be referred to as an embedding. This processing performed in box 207 may be expressed mathematically,

e=T(a,x)

where x is the raw feature vector, T(a,x) denotes a transformation from [symbol] ^{P} to [symbol] ^{Q} parameterized by a vector of parameters a and carried out on feature vector x, and e is the output embedding with e∈ [symbol] ^{Q}. In some embodiments, the transformation T is a linear operation such as a matrix multiplication. In some embodiments, the transformation T is a nonlinear operation. In some embodiments, the transformation T is a combination of linear and nonlinear operations. In some embodiments, the transformation T includes processing by a deep neural network (DNN). In some embodiments, the transformation T includes a normalization step such that the output embedding e has unit norm. Mathematically, this can be expressed in two processing steps as

$$\tilde{e} = T ( a , x )$$

$$e = \frac{\tilde{e}}{‖ \tilde{e} ‖}$$

where \tilde{e}∈ [symbol] ^{Q} and ∥.∥ indicates the two-norm. The normalized embedding is an element of [symbol] ^{Q}, namely e∈ [symbol] ^{Q}, but is further constrained by the normalization to be on the surface of a Q-dimensional unit hypersphere. In some embodiments the processing performed in box 207 corresponds to operations carried out in the feature-space transformation unit 107 of the classification inference system 100.

After the feature-space transformation is performed in box 207, the classification inference process 200 continues by computing classification metrics (box 209). In some embodiments this includes a computation on embedding e (obtained in box 207) for each a set of N_{I} established classes. The result of the computation is a classification metric for each class. For class n, the classification metric can be denoted as ρₙ. In some embodiments, each established class is represented by a corresponding vector in the embedding space. For instance, class n may be represented by a vector cₙ. In some embodiments, the process in box 207 computes classification metrics comprising inner products between embedding e and the respective class vectors cₙ. Mathematically, this can be expressed as

ρₙ=e^{T}cₙ

where the vectors are assumed to be column vectors and the superscript T denotes transposition to a row vector to compute the scalar inner product. In some embodiments, an inner product between two vectors is referred to as a similarity between the two vectors. In some embodiments, the processing of box 207 computes classification metrics comprising distances between embedding e and the respective class vectors cₙ, which can be expressed mathematically as ρₙ=∥e−cₙ∥. As will be understood by those of ordinary skill in the art, other classification metrics can be used.

The classification inference process 200 continues by determining classification decisions based on the classification metrics ρₙ computed earlier (box 211). For some classification metrics, such as an inner product or similarity metric, a large value of the metric ρₙ may indicate that embedding e should be ascertained to belong to class n. In such cases, a classification decision may be determined by identifying the class for which the classification metric ρₙ is maximized:

$$\hat{n} = arg {max}_{n ∈ \{ 1 , 2 , … {N}_{I} \}} {ρ}_{n}$$

Then the embedding is determined to belong to class \hat{n} if the maximum classification metric ρₙ is above a certain threshold E, which in some cases may depend on the class n and in some cases may be independent of the class n. If the maximum classification metric ρ_{\hat{n}} does not exceed a threshold ∈, the embedding is determined to not belong to any of the N_{I} established classes. The classification determination can be expressed mathematically as

$$y = \{ \begin{matrix}\hat{n} , & {ρ}_{\hat{n}} \geq {ϵ}_{n} \\ 0 , & {ρ}_{\hat{n}} < {ϵ}_{n}\end{matrix}$$

where a designation of 0 is assigned to embeddings which are determined to not belong to any of the established classes. Those of ordinary skill in the art will understand that other designations or class labels could be applied.

For some classification metrics, such as a distance metric, a small value of the metric ρₙ for an embedding e indicates that the embedding should be ascertained to belong to class n. In such cases, a classification decision is determined by identifying the class for which the classification metric ρₙ is minimized:

$$\hat{n} = arg {min}_{n ∈ \{ 1 , 2 , … {N}_{I} \}} {ρ}_{n}$$

Then, the embedding is determined to belong to class \hat{n} if the minimum classification metric ρ_{\hat{n}} is below a certain threshold ∈, which in some cases may depend on the class n and in some cases may be independent of the class n. If the minimum classification metric ρ_{\hat{n}} is not below a threshold ∈, the embedding is determined to not belong to any of the established classes. The classification determination can be expressed mathematically as

$$y = \{ \begin{matrix}\hat{n} , & {ρ}_{\hat{n}} \leq {ϵ}_{n} \\ 0 , & {ρ}_{\hat{n}} > {ϵ}_{n}\end{matrix}$$

where a designation of 0 is assigned to embeddings which are determined to not belong to any of the established classes. Those of ordinary skill in the art will understand that other designations or class labels could be applied. It should be noted that in some embodiments the processes carried out in boxes 209 and 211 correspond to operations carried out in the classifier unit 111 of the classification inference system 100. Those of ordinary skill in the art will understand that other formulations can be used to determine classification decisions.

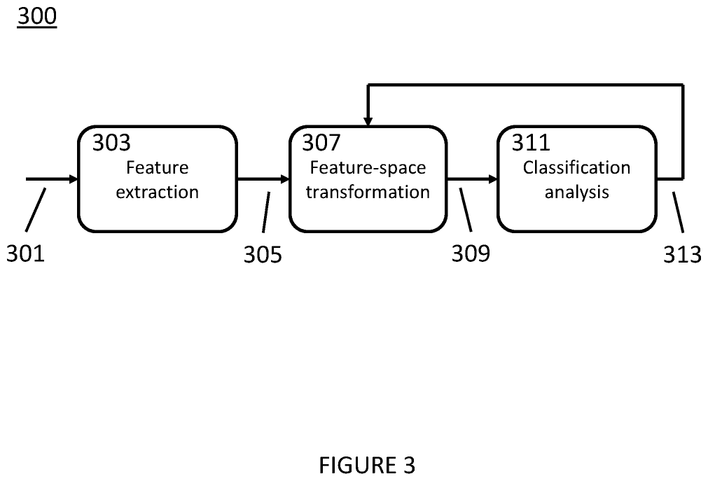

FIG. 3 depicts a block diagram of a classification training system 300 in accordance with embodiments of the deep-learning classifier training system and method. The classification training system 300 receives an input on line 301. The input comprises a signal and a class label for the signal. In some embodiments, the input includes a digital audio waveform signal containing a speech component uttered by a known talker as well as a label identifying the talker. In other embodiments, the input includes an image signal containing a face of a known person as well as a label identifying the person.

A feature extraction unit 303 receives the input on line 301 and generates an example feature vector for the class designated by the input label. The example feature vector is a mathematical representation of the input signal provided on line 301. The example feature vector and the class label are provided as an output by the feature extraction unit 303 on line 305. In some embodiments the example feature vector is interpreted as a vector in a feature space. A feature-space transformation unit 307 receives the labeled example feature vector as input on line 305. In some embodiments the feature-space transformation unit 307 carries out mathematical operations on the input example feature vector provided on line 305 to generate an output example vector in a different feature space than that of the input feature vector. In some embodiments, the output example vector is referred to as an embedding. The corresponding feature space of the output example vector is referred to as an embedding space. In some embodiments, processing performed by the feature-space transformation unit 307 includes using a deep neural network (DNN). In some embodiments, the processing performed by the feature-space transformation unit 307 includes a normalization operation such that the output embedding has unit norm.

The feature-space transformation unit 307 provides an embedding vector as output on line 309. The embedding vector is received as input by a classification analysis unit 311. In some embodiments, the feature extraction unit 303 and the feature-space transformation unit 307 are carried out using batch processing on a batch of labeled inputs such that a batch of labeled embeddings are provided to the classification analysis unit 311 prior to the classification analysis unit 311 carrying out any operations. In some embodiments, the classification analysis unit 311 analyzes a batch of labeled embeddings to derive a quantitative assessment of the classification performance. A batch may consist of one labeled embedding generated from one example from the training set, a subset of labeled embeddings generated from a subset of the training set of examples, or a set of labeled embeddings generated from the full training set of examples. The quantitative assessment can be equivalently referred to as a loss function, a cost function, or an objective function.

The value of the loss function and associated information computed by the classification analysis unit 311 is provided on line 313 to the feature-space transformation unit 307. Based on the loss function value and associated information received on line 313, the feature-space transformation unit 307 adjusts its processing for a subsequent batch of labeled inputs so as to improve the quantitative assessment of the classification performance for the subsequent batch. In other words, to reduce the loss function as computed for the subsequent batch. In embodiments where a deep neural network (DNN) is used, the model parameters are adapted based on backpropagating the gradients of the loss function with respect to the model parameters. In some embodiments the batch processing is iterated for multiple batches of labeled inputs to progressively reduce the loss function as batches are sequentially processed. In some embodiments, iterating over multiple batches of labeled inputs progressively improves the feature-space transformation for classification.

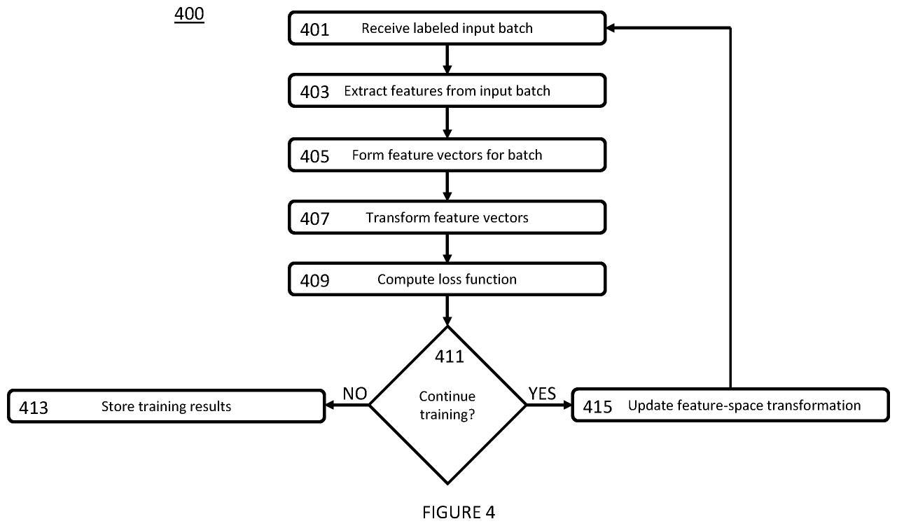

FIG. 4 is a flow diagram illustrating the classification training process 400 in accordance with embodiments of the deep-learning classifier training method. The classification training process 40 begins by receiving a batch of input signals and corresponding class labels (box 401). In typical cases, a batch consists of numerous signals, each with a corresponding class label. In typical cases, a large labeled training set is available from which numerous batches can be drawn for the classification training. In some embodiments a batch consists of one labeled signal.

The process 400 then extracts features from the batch of input signals (box 403). The extracted features then are aggregated into respective raw feature vectors (box 405). The raw feature vectors are labeled, meaning that each raw feature vector is associated with an established class. Those of ordinary skill in the art will understand that it is also possible to derive labeled raw feature vectors from an entire training set in a precomputation stage rather than batch-by-batch as part of the training batch processing. In such an alternate approach, the classification training initiates with drawing a batch of labeled raw feature vectors from the precomputed set.

The process 400 continues by transforming batch of labeled raw feature vectors respectively into labeled embedding vectors by a feature-space transformation process (box 407). In some embodiments the feature-space transformation process is that which is performed by the feature-space transformation unit 307 shown in FIG. 3. In some embodiments, the feature-space transformation process include a deep neural network (DNN). In some embodiments, the feature-space transformation process includes recursive neural network (RNN) units. In some embodiments, the feature-space transformation process includes a normalization process such that the output embedding vectors have unit norm. In some embodiments, the batch of labeled raw feature vectors processed by the feature-space transformation include a training subset and a validation subset. In these cases, the validation subset is configured to consist of the same labeled raw feature vectors for each iteration of the classification training process.

The process 400 then evaluates a loss function, or equivalently a cost function or an objective function, for the batch of labeled embedding vectors computed in box 409. In some embodiments, the loss function consists of multiple components that are linearly combined. In cases where the batch of raw labeled feature vectors consists of a training subset and a validation subset, the loss function is evaluated separately for each subset. Next, a determination is made as to whether to continue training (box 411). In some embodiments the determination is based in part on the loss function evaluated in box 407. In some embodiments, the determination is based in part on the loss function evaluated in box 407 for a validation subset of the batch of labeled embedding vectors. In some embodiments, the determination is based in part on the loss function evaluated in box 407 for a training subset of the batch of labeled embedding vectors. In some embodiments, the determination is based at least in part on a metric other than the loss function evaluated for a validation subset. In some embodiments, the determination is based at least in part on a metric other than the loss function evaluated for a training subset.

If the determination in box 411 indicates that training should not continue, the classification training process 400 then stores the training results (box 413). In some embodiments this includes storing the feature-space transformation parameters, which can be referred to as a model. In some embodiments, this includes computing and storing representation vectors for the established classes. The representation vectors for the established classes can be computed as centroids of the labeled embedding vectors of the respective classes.

If the determination in box 411 indicates that training should continue, the classification training process 400 continues by updating the parameters of the feature-space transformation (box 415). In some embodiments, the updated parameters of the feature-space transformation include DNN model parameters. In some embodiments, the updated parameters further include parameters of the loss function. In some embodiments the updating process includes computing gradients of the loss function with respect to the various feature-space transformation parameters. The parameter updates can be based at least in part on the computed gradients.

After the feature-space transformation is updated in box 415, the classification training process 400 continues in box 401 with receiving a new batch of input signals and labels. As explained earlier, in alternate embodiments where labeled raw feature vectors are computed in advance of the iterative training process, the classification is configured so as to continue with receiving a new batch of labeled raw feature vectors. The training continues iterating with new batches until a determination is made in box 411 to end the training process.

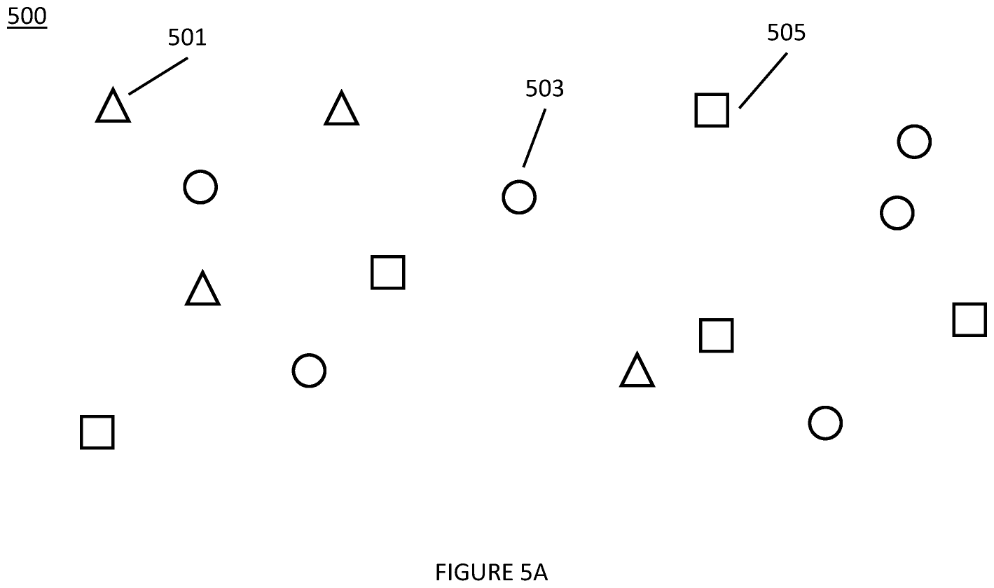

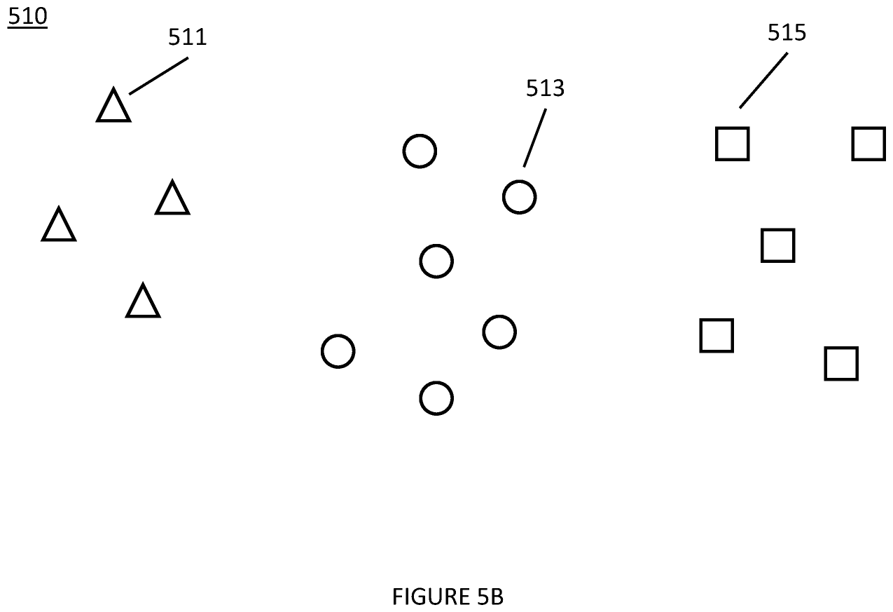

FIG. 5A is a depiction of labeled examples in a raw feature space 500 according to some embodiments of the system and method. The raw feature space 500 is depicted as a two-dimensional space. As will be understood by those of ordinary skill in the art, a raw feature space may consist of more than two dimensions. Various examples of several classes are depicted in raw feature space 500. The examples of one class are depicted as triangles in the raw feature space, for example triangle 501. The examples of a second class are depicted as circles in feature space, for example circle 503. The examples of a third class are depicted as squares in feature space, for example square 505. Note that the examples of the various classes are dispersed across the feature space 500. As will be understood by those of ordinary skill in the art, the shapes serve as an indication of which class each example belongs to and do not indicate any further properties of the examples.

FIG. 5B is a depiction of labeled examples in a conditioned feature space 510 according to some embodiments of the system and method. The conditioned feature space 510 is depicted as a two-dimensional space. As will be understood by those of ordinary skill in the art, a conditioned feature space may consist of more than two dimensions. As in FIG. 5A, various examples of several classes are depicted in conditioned feature space 510. In the conditioned feature space, however, the examples of each class are grouped together. For instance, triangle 511 is grouped with other triangles, circle 513 is grouped with other circles, and square 515 is grouped with other squares. This grouping illustrates class compaction in the conditioned feature space 510. Furthermore, in the conditioned feature space 510, the group of triangles, the group of circles, and the group of squares are respectively separated. This is an illustration of inter-class spread in the conditioned feature space 510. In classification inference system 100, the feature-space transformation 107 may be configured to improve class compaction and inter-class spread in the conditioned feature space with respect to the input raw feature space. In classification training system 300, the feature-space transformation 307 may be derived to improve class compaction and inter-class spread with respect to the input raw feature space, for instance via a learning process based on backpropagation of gradients of a loss function computed in classification analysis block 311. As will be understood by those of ordinary skill in the art, a conditioned feature space based on transforming a raw feature space may consist of a higher number, the same number, or a lower number of dimensions than the raw feature space.

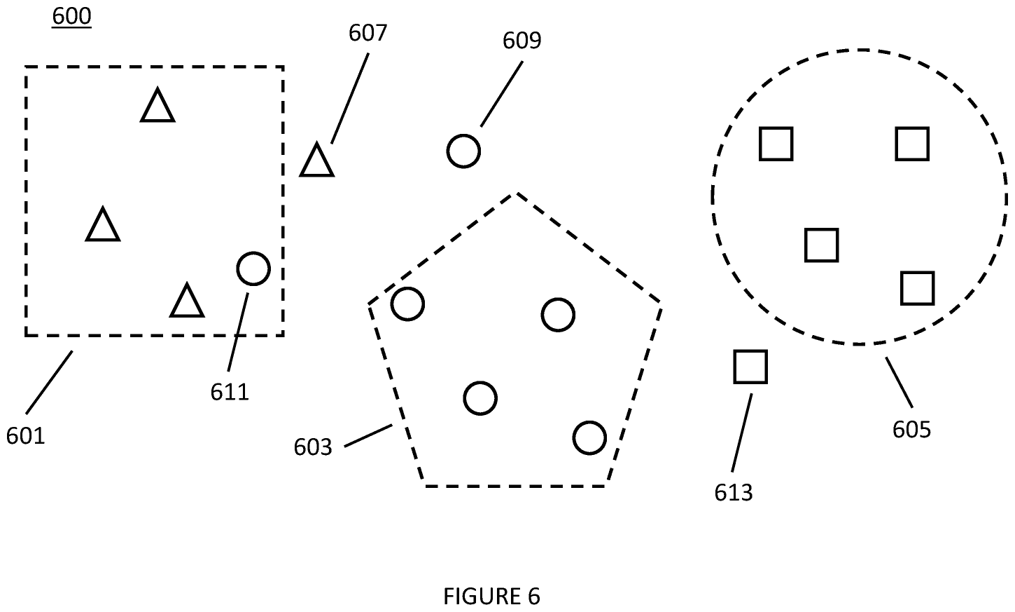

In the training process outlined in the flow diagram of FIG. 4, the classifier is trained iteratively in accordance with a training objective. Through the iterative process, the classifier learns a feature-space transformation for conditioning the feature space. FIG. 6 is a depiction of labeled examples and arbitrarily shaped classification regions in a feature space. FIG. 6 illustrates a conditioned feature space 600 at an intermediate point in the training process in accordance with embodiments of the system and method. The depiction includes three classes whose examples are denoted respectively by triangles, circles, and squares. For each class, a classification region is indicated. For the class whose examples are denoted by triangles, classification region 601 is indicated. For the class whose examples are denoted by circles, classification region 603 is indicated. For the class whose examples are denoted by squares, classification region 605 is indicated. In some embodiments, a classification region is specified for each established class and the training objective is to minimize a misclassification metric for the labeled examples with respect to the specified classification regions. For instance, with reference to FIG. 6, an objective in accordance with some embodiments is to condition the feature space so that the examples depicted by triangles fall within classification region 601, the examples depicted by circles fall within classification region 603, and the examples depicted by squares fall within classification region 605.

Mathematically, some embodiments use an objective function for training which rewards correct classifications, such as the triangles within region 601, the circles within region 603, and the squares within region 605, and which penalizes incorrect classifications, for instance the example denoted by triangle 607, the examples indicated by circles 609 and 611, and the example indicated by square 613. In some embodiments, an objective function that rewards correct classifications and penalizes incorrect classifications is formed by assigning a cost to each labeled example with respect to each classification region.

For each established class, labeled examples belonging to that class, which may be referred to as in-class examples, are either correctly classified or incorrectly classified. A correctly classified in-class example can be referred to as a true positive. An incorrectly classified in-class example, such as the triangle 607 which falls outside of its correct classification region 601, can be referred to as a false negative. For each class, labeled examples not belonging to the class, which can be referred to as out-of-class examples, may either be correctly classified or incorrectly classified. A correctly classified out-of-class example may be referred to as a true negative. An incorrectly classified out-of-class example, such as the circle 611 which falls inside an incorrect classification region 601, may be referred to as a false positive (with respect to the triangle class in whose classification region it falls).

Noting the above definitions, for a given class any particular example in feature space may be categorized as a true positive, a false positive, a true negative, or a false negative. Furthermore, with respect to a given class, any in-class example may be categorized as either a true positive or a false negative, and any out-of-class example may be categorized as either a true negative or a false positive. For an ideal classifier for a given class, all in-class examples would fall in the true positive category and all out-of-class examples would fall in the true negative category; there would be no in-class examples in the false negative category and no out-of-class examples in the false positive category. In some embodiments, a classifier training objective for each given class is formulated based on these categories as explained in the following.

In classifier training, an objective function may be formulated such that the goal of training is to minimize the objective function. As such, a classifier training objective for a given class can be formulated based on two components, one for in-class examples and one for out-of-class examples, wherein correctly classified examples are each assigned a cost of zero and incorrectly classified examples are each assigned a cost of one, as in:

$${\hat{F}}_{I N} ( C ) = {\sum }_{{e}_{m} ∈ {\{ {e}_{1} , {e}_{2} , … , {e}_{M} \}}_{{e}_{m} ∈ C}} {\hat{f}}_{I N} ( {e}_{m} , C )$$

$$with {\hat{f}}_{I N} ( {e}_{m} , C ) = \{ \begin{matrix}0 if {e}_{m} is in reg ( C ) & ( true positive ) \\ 1 if {e}_{m} is not in reg ( C ) & ( false negative )\end{matrix} \\ {\hat{F}}_{OUT} ( C ) = {\sum }_{{e}_{m} ∈ {\{ {e}_{1} , {e}_{2} , … , {e}_{M} \}}_{{e}_{m} ∉ C}} {\hat{f}}_{OUT} ( {e}_{m} , C ) \\ with {\hat{f}}_{OUT} ( {e}_{m} , C ) = \{ \begin{matrix}0 if {e}_{m} is not in reg ( C ) & ( true positive ) \\ 1 if {e}_{m} is in reg ( C ) & ( false negative )\end{matrix} \\ \hat{F} ( C ) = {α}_{I N} {\hat{F}}_{I N} ( C ) + {α}_{O U T} {\hat{F}}_{O U T} ( C )$$

where eₘ denotes an embedding from the set of labeled examples in a classifier training batch {e₁, e₂, . . . , e_{M}}, reg(C) denotes the classification region for class C, \hat{F}_{IN}(C) is a per-class objective function component for in-class examples of class C, \hat{ƒ}_{IN}(eₘ, C) is a per-example objective function component for in-class examples of class C, \hat{F}_{OUT}(C) is a per-class objective function component for out-of-class examples of class C, \hat{ƒ}_{OUT}(eₘ, C) is a per-example objective function component for out-of-class examples of class C, and where \hat{F}(C) is an overall objective function for class C formed by summing the in-class objective function component and the out-of-class function component with respective weights α_{IN} and α_{OUT}. A complete objective function for the training batch can be formed for the per-class functions by summing over the classes:

$$\hat{Φ} = {\sum }_{n} \hat{F} ( {C}_{n} )$$

where n is a class index. Alternatively, a complete objective function for the training batch can be formed by first forming complete in-class and out-of-class components and then combining them:

$${\hat{Φ}}_{IN} = {\sum }_{n} {\hat{F}}_{IN} ( {C}_{n} )$$

$${\hat{Φ}}_{OUT} = {\sum }_{n} {\hat{F}}_{OUT} ( {C}_{n} )$$

$$\hat{Φ} = {β}_{IN} {\hat{Φ}}_{IN} + {β}_{OUT} {\hat{Φ}}_{OUT}$$

where β_{IN} and β_{OUT} are combination weights for the in-class and out-of-class objective function components, respectively. Note that for the in-class objective function components \hat{ƒ}_{IN}(eₘ, C), \hat{F}_{IN}(C), and \hat{Φ}_{IN}, true positive examples (correct classifications) incur a cost of zero and false negative examples (incorrect classifications) incur a positive cost. Note that for the out-of-class objective function components \hat{f}_{OUT}(eₘ, C), \hat{F}_{OUT}(C), and \hat{Φ}_{OUT}, true negative examples (correct classifications) incur a cost of zero and false positive examples (incorrect classifications) incur a positive cost. Thus, in this formulation, correct classifications incur zero cost whereas incorrect classifications incur positive cost. The complete objective function is thus a quantification of the number of misclassified examples, and a minimization of the complete objective function is achieved by having no incorrect classifications.

In accordance with embodiments of the system and method, the combining weights α_{IN}, α_{OUT}, β_{IN}, and β_{OUT} in the various objective function formulations described above may be determined based on classifier design considerations such as the relative importance of different misclassification errors in a classification task. In some cases, the per-class weights α_{IN} and α_{OUT} for a given class may be determined based on the number of examples in the class, for instance

$${α}_{IN} ( C ) = \frac{1}{\vert C \vert} \\ {α}_{OUT} ( C ) = \frac{1}{M - \vert C \vert}$$

where |C| denotes the cardinality of class C, namely the number of in-class examples for class C, M is the total number of examples in the training batch, and the notation has been adjusted to indicate that the weights may be functions of the class C. With this choice for the weighting coefficients, the collection of in-class and out-of-class examples for a given class have an aggregated equal importance in the cost function. Because there are typically more out-of-class examples than in-class examples, the cost penalty for a misclassified in-class example (a false negative) is weighted higher than the cost penalty for a misclassified out-of-class example (a false positive) in this formulation. In other cases, the per-class weights may be determined based on the total number of examples in the training batch, for instance

$${α}_{IN} = {α}_{O U T} = \frac{1}{M}$$

in which case each example is equally weighted, meaning that the cost penalty for a misclassified in-class example (a false negative) is given the same weight as the cost penalty for a misclassified out-of-class example in this formulation. In some embodiments, the weights β_{IN} and β_{OUT} are determined using similar design considerations as described above for the weights α_{IN} and α_{OUT}. In some embodiments, the weights β_{IN} and β_{OUT} are determined based on the total number of in-class and out-of-class examples for all N classes in the training batch, for instance

$${β}_{IN} ( C ) = \frac{1}{{\sum }_{n = 1}^{N} \vert {C}_{n} \vert} = \frac{1}{M} \\ {β}_{OUT} ( C ) = \frac{1}{NM - {\sum }_{n = 1}^{N} \vert {C}_{n} \vert} = \frac{1}{( N - 1 ) M}$$

where Σₙ₌₁^{N}|Cₙ|=M since each example in the training batch is an in-class example for one and only one class. The above formulation essentially penalizes individual false negative errors more than individual false positive errors, whereas in other cases β_{IN} and β_{OUT} may be determined based on the total number of examples aggregated over all classes in the training batch, for instance

$${β}_{IN} = {β}_{OUT} = \frac{1}{N M}$$

which essentially penalizes individual false negative errors and individual false positive errors with equal weighting. Note that there are M distinct examples in the training batch, but that for the purpose of the cost function each example is tallied as an in-class or out-of-class example with respect to each of the N classes, for an aggregate tally of NM examples. As will be understood by those of ordinary skill in the art, other design choices which implement different cost tradeoffs between misclassifications are within the scope of the present invention. As will also be understood by those of ordinary skill in the art, some embodiments of the system and method use other approaches to linearly combining the respective per-example, per-class, and aggregated in-class and out-of-class cost functions to form an overall objective function.

Referring again to FIG. 6, classification regions of different shapes are depicted in accordance with some embodiments of the system and method. Classification regions, as in FIG. 6, may be specified by boundaries. For instance, a circular classification region may refer to a classification region bounded by a circle. In some embodiments, classification regions of a common shape are specified, for example to simplify training and inference. In some embodiments, classification regions with hyperspherical boundaries are specified, for example to simplify training and inference by facilitating formulation of mathematically tractable objective functions and simple classification criteria. Mathematical tractability of an objective function may include characteristics such as closed-form expression and differentiability to support learning via gradient backpropagation.

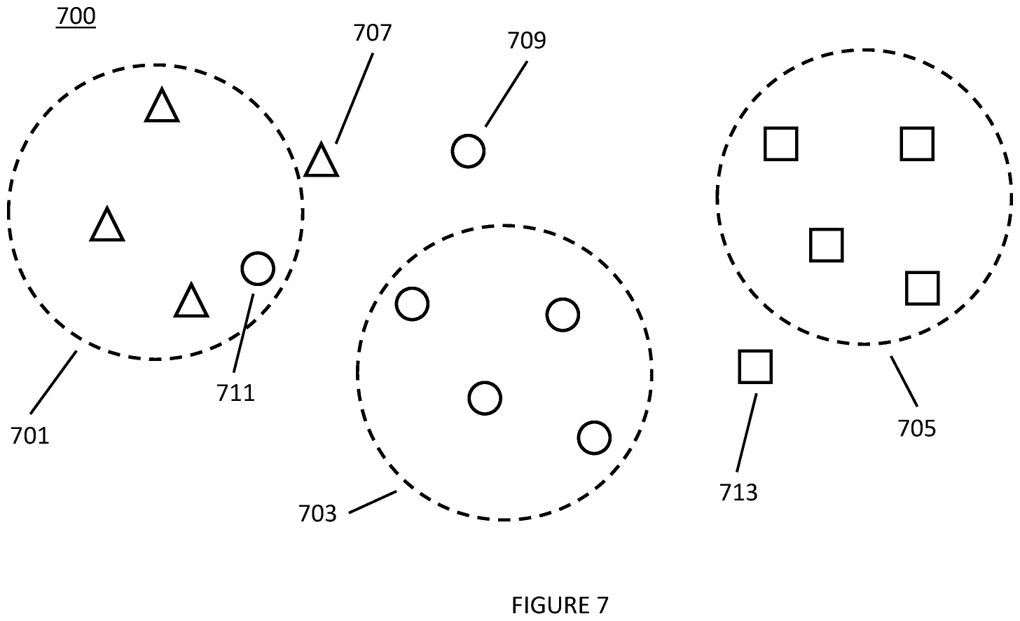

FIG. 7 is a depiction of labeled examples and circular classification regions in a feature space. FIG. 7 illustrates circular classification regions for the respective classes in accordance with embodiments of the system and method. As will be understood by those of ordinary skill in the art, circles are hyperspheres in a two-dimensional space; in other words, FIG. 7 provides a two-dimensional depiction of hyperspherically bounded classification regions. While the circular classification regions depicted in FIG. 7 are of the same size, those of ordinary skill in the art will understand that hyperspherically bounded classification regions of different sizes for different classes are within the scope of the present invention.

A hyperspherically bounded classification region reg(Cₙ) for a class Cₙ in a Q-dimensional feature space [symbol] ^{Q} can be defined by a Q-dimensional class center cₙ∈ [symbol] ^{Q} and a radius δₙ. The region reg(Cₙ) comprises all points in the feature space that are at a distance δₙ from the center cₙ or closer. Defining a distance between vectors v, w∈ [symbol] ^{Q} in the feature space as d(v, w)=∥v−w∥, the classification region reg(Cₙ) for example embeddings can be defined as comprising the points v∈ [symbol] ^{Q} for which d(v, cₙ)≤δₙ with the further constraint that ∥v∥=1 for cases where embeddings are normalized to unit norm. For unit-norm embeddings, the specified distance-bounded classification region reg(Cₙ) is a disc-shaped region on the surface of the Q-dimensional unit hypersphere. In accordance with embodiments of the present inventions, objective functions for in-class and out-of-class examples can then be defined respectively as

\hat{ƒ}_{IN}(e, Cₙ)=u[d(e, cₙ)−δₙ]

\hat{ƒ}_{OUT}(e, Cₙ)=u[δₙ−d(e, cₙ)]

where u[t] is the unit step function such that u[t]=1 for t≥0 and u[t]=0 for t<0, or in cases with different in-class and out-of-class distance thresholds as

\hat{ƒ}_{IN}(e, Cₙ)=u[d(e, cₙ)−δ_{n,IN}]

\hat{ƒ}_{OUT}(e, Cₙ)=u[δ_{n,OUT}−d(e, cₙ)]

where the different distance thresholds may be incorporated to impose a margin between distinct classes.

The squared distance between two vectors v, w∈ [symbol] ^{Q} is given by d(v, w)²=(v−w)^{T}(v−w)=v^{T}v+w^{T}w−2v^{T}w. If v and w are unit-norm vectors, d(v, w)²=(v−w)^{T}(v−w)=2(1−v^{T}w). Defining the similarity between two unit-norm vectors as s(v, w)=v^{T}w, the distance and the similarity are related as d(v,w)²=2(1−s(v, w)) or equivalently as

$$s ( v , w ) = 1 - \frac{1}{2} {d ( v , w )}^{2} .$$

Given this relationship, a hyperspherically bounded classification region specified by a unit-norm center cₙ∈Z and a radius δₙ can be equivalently specified by the center cₙ and a similarity threshold

$${φ}_{n} = 1 - \frac{1}{2} {δ}_{n}^{2} .$$

Specifically, the region reg(Cₙ) can be defined as comprising the points v∈ [symbol] ^{Q} for which s(v, cₙ)≥ϕₙ with the further requirement that ∥v∥=1. For unit-norm embeddings, the specified similarity-bounded classification region reg(Cₙ) is a disc-shaped region on the surface of the Q-dimensional unit hypersphere.

In accordance with embodiments of the system and method, corresponding objective functions for in-class and out-of-class examples can then be defined respectively as

\hat{ƒ}_{IN}(x, Cₙ)=u[ϕₙ−s(x, cₙ)]

\hat{ƒ}_{OUT}(x, Cₙ)=u[s(x, cₙ)−ϕₙ]

or in cases with different in-class and out-of-class similarity thresholds as

\hat{ƒ}_{IN}(x, Cₙ)=u[ϕ_{n,IN}−s(x, cₙ)]

\hat{ƒ}_{OUT}(x, Cₙ)=u[s(x, cₙ)−ϕ_{n,OUT}]

where the different similarity thresholds may be incorporated to impose a margin between distinct classes. While specifying different thresholds for different classes is within the scope of the invention, in preferred embodiments the same threshold may be used for all classes so as to simplify training and inference. In that case, objective functions for in-class and out-of-class examples corresponding to the above examples can be defined respectively as

\hat{ƒ}_{IN}(x, Cₙ)=u[ϕ_{IN}−s(x, cₙ)]

\hat{ƒ}_{OUT}(x, Cₙ)=u[s(x, cₙ)−ϕ_{OUT}]

Without loss of generality, the class subscript is dropped in threshold parameters as well as some other potentially class-dependent parameters in subsequent formulations of objective functions.

As explained earlier, in accordance with embodiments of the system and method, per-example objective functions for in-class and out-of-class examples can be combined to form per-class objective functions, for instance

$${\hat{F}}_{I N} ( C ) = {\sum }_{{e}_{m} ∈ {\{ {e}_{1} , {e}_{2} , … , {e}_{M} \}}_{{e}_{m} ∈ C}} {\hat{f}}_{I N} ( {e}_{m} , C )$$

$${\hat{F}}_{OUT} ( C ) = {\sum }_{{e}_{m} ∈ {\{ {e}_{1} , {e}_{2} , … , {e}_{M} \}}_{{e}_{m} ∉ C}} {\hat{f}}_{OUT} ( {e}_{m} , C )$$

where {e₁, e₂, . . . , e_{M}} is the set of all labeled examples in the training batch. In accordance with embodiments of the system and method, per-class objective functions can be formed as a linear combination

\hat{F}(C)=α_{IN}\hat{F}_{IN}(C)+α_{OUT}\hat{F}_{OUT}(C)

with weights α_{IN} and α_{OUT} applied respectively to the in-class example objective function and the out-of-class example objective function for the class. A complete objective function for training can then be formed by summing over the classes:

$$\hat{Φ} = {\sum }_{n} \hat{F} ( {C}_{n} ) .$$

In some embodiments, overall in-class and out-of-class objective functions are first formed and then combined linearly with weights β_{IN} and β_{OUT} to form a complete objective function:

$${\hat{Φ}}_{IN} = {\sum }_{n} {\hat{F}}_{IN} ( {C}_{n} )$$

$${\hat{Φ}}_{OUT} = {\sum }_{n} {\hat{F}}_{OUT} ( {C}_{n} )$$

$$\hat{Φ} = {β}_{IN} {\hat{Φ}}_{IN} + {β}_{OUT} {\hat{Φ}}_{OUT}$$

where for some choices of the various combining weights this formulation of the complete objective function and the prior formulation of the complete objective function are equivalent. As will be understood by those of ordinary skill in the art, various choices can be used for the combining weights α_{IN}, α_{OUT}, β_{IN}, β_{OUT}.

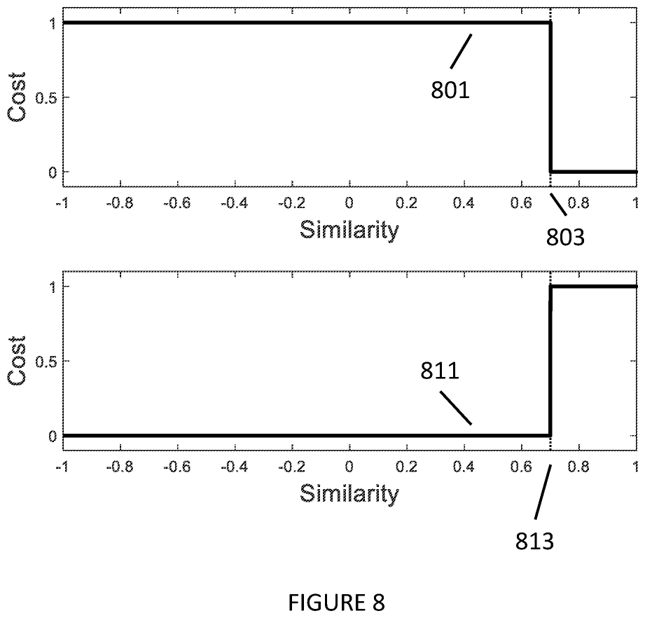

FIG. 8 depicts plots of cost functions for in-class and out-of-class examples in accordance with embodiments of the system and method. The plotted function 801 illustrates a cost function \hat{ƒ}_{IN}(eₘ, C)=u[ϕ_{IN}−s(eₘ, c)] for in-class examples with similarity threshold 803 set as ϕ_{IN}=0.7. The plotted function 811 illustrates a cost function \hat{ƒ}_{OUT}(eₘ, C)=u[s(eₘ, c)−ϕ_{OUT}] for out-of-class examples with similarity threshold 813 set as ϕ_{OUT}=0.7. The depicted objective functions for in-class and out-of-class examples have two key characteristics in accordance with embodiments of the system and method. First, each objective function assigns a positive cost to misclassified examples, in other words a cost penalty (recall that minimizing the cost is the training objective) and a zero cost to correctly classified examples. Second, each objective function incorporates a classification criterion. Considering the objective function for in-class examples in the top panel, a correctly classified in-class example has a similarity above (or equal to) the threshold 803, and thus a zero cost according to the objective function 801. An incorrectly classified in-class example has a similarity below the threshold 803, and thus a cost of one according to the objective function 801. Considering the objective function for out-of-class examples in the bottom panel, a correctly classified out-of-class example has a similarity below the threshold 813, and thus a zero cost according the objective function 811. An incorrectly classified out-of-class example has a similarity above (or equal to) the threshold 813, and thus a cost of one according to the objective function 811. Furthermore, if a classifier is configured, for example by training, to minimize an overall objective function based on these per-example objective functions, a robust inference rule for classification of unlabeled examples can be established based on the threshold 803, 813. If the similarity of an unlabeled example exceeds the threshold 803 for a particular class, it can be reliably assigned to that class. If the similarity of an unlabeled example falls below the threshold 813 for a particular class, it can be reliably excluded from that class.

In the preceding, the various objective functions have been notated with a hat accent, i.e. as \hat{θ}, \hat{F}, and \hat{Φ}, since they correspond to an idealized enumeration of incorrect classifications. Note that the idealized objective functions are characterized by a step transition at the class-boundary threshold. In some embodiments, a finite slope is incorporated at the transition such that the objective function is differentiable and such that a margin, in other words a separation between in-class and out-of-class examples and thereby a separation between classes, is encouraged at the class boundary. Furthermore, note that idealized objective functions are characterized by flat regions on either side of the class-boundary threshold.

In some embodiments, a non-zero slope is incorporated throughout the objective functions so as facilitate learning by gradient backpropagation. Objective functions for in-class and out-of-class examples in accordance with some embodiments incorporate these aforementioned transition and gradient characteristics, for instance by incorporating parameters and nonlinear functions as in:

ƒ_{IN}(eₘ, C)=σ[μ_{IN}(ϕ−s(eₘ, c))]+γ_{IN}relu(ϕ−s(eₘ, c))

ƒ_{OUT}(eₘ, C)=σ[μ_{OUT}(s(eₘ, c)−ϕ)]+γ_{OUT}relu(s(eₘ, c)−ϕ)

where σ[t] denotes a sigmoid function, relu(t)=max (0, t), and the threshold parameter is set to ϕ in both functions. The parameters μ_{IN} and μ_{OUT} establish in part the slopes of the respective objective functions in their class-boundary transition regions. The parameters γ_{IN} and γ_{OUT} establish in part the slopes of the respective objective functions in regions corresponding to incorrect classifications, namely the region below the similarity threshold for the in-class objective function and the region above the similarity threshold for the out-of-class objective function. One reason for the slope is to encourage moving misclassified examples toward correct classification regions via gradient backpropagation.

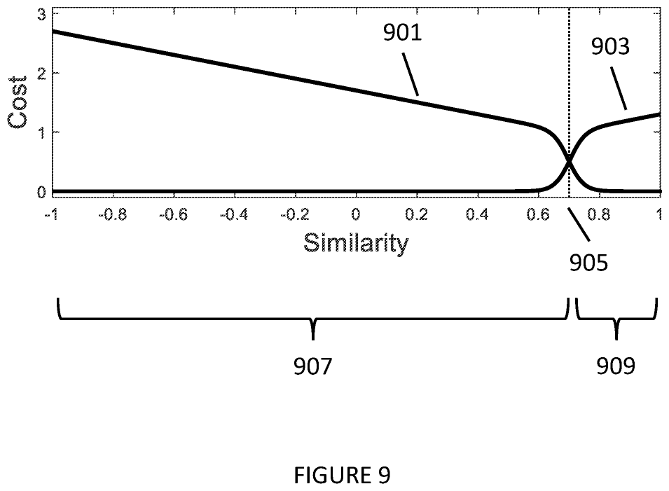

FIG. 9 is a plot of per-example cost functions in accordance with embodiments of the system and method. FIG. 9 depicts plots of objective functions for in-class and out-of-class examples as specified in the above equations. Plotted function 901 illustrates the objective function

ƒ_{IN}(eₘ, C)=σ[μ_{IN}(ϕ−s(eₘ, c))]+γ_{IN}relu(ϕ−s(x, c))

for in-class examples with parameters ϕ=0.7, μ_{IN}=40, and γ_{IN}=1. Plotted function 903 illustrates the objective function

ƒ_{OUT}(eₘ, C)=σ[μ_{OUT}(s(eₘ, c)−ϕ)]+γ_{OUT}relu(s(eₘ, c)−ϕ)

for out-of-class examples with parameters ϕ=0.7, α_{OUT}=40, and γ_{OUT}=1. The parameter ϕ establishes the threshold 905. The parameter μ_{IN} establishes in part the slope of in-class objective function 901 in the class-boundary transition region around threshold 905. The parameter γ_{IN} establishes in part the slope of function 901 in the misclassification region 907 below threshold 905. The parameter μ_{OUT} establishes in part the slope of out-of-class objective function 903 in the class-boundary transition region around threshold 905. The parameter γ_{OUT} establishes in part the slope of function 903 in the misclassification region 909 above threshold 905. Those of ordinary skill in the art will understand that although in this depiction, equivalent values are used for the parameters in the in-class objective function and the out-of-class objective functions, different parameters may be used for the different functions.

In some embodiments, objective functions for in-class and out-of-class examples are specified in terms of different functions and parameters as those specified in the formulation above. For instance, additional slope and bias functions and parameters may be incorporated as in

ƒ_{IN}(e_{m, C})=σ[μ_{IN}(ϕ_{IN}−s(eₘ, c))]+γ_{IN}relu(ϕ_{IN}−s(eₘ, c))−λ_{IN}relu(s(eₘ, c)−ϕ_{IN})+λ_{IN}(1−ϕ_{IN})

ƒ_{OUT}(eₘ, C)=σ[α_{OUT}(s(eₘ, c)−ϕ_{OUT})]+γ_{OUT}relu(s(eₘ, c)−ϕ_{OUT})−λ_{OUT}relu(ϕ_{OUT}−s(eₘ, c))+λ_{OUT}(1+ϕ_{OUT})

where the additional relu( ) terms with the λ_{IN} and λ_{OUT} coefficients facilitate control of the cost functions in regions of correct classification. In alternate embodiments, objective functions for in-class and out-of-class examples are specified as piecewise linear functions. As will be understood by those of ordinary skill in the art, the various objective functions described for in-class and out-of-class examples are approximations of the idealized classification-error enumerating functions discussed earlier. As will further be understood by those of ordinary skill in the art, other objective functions that are approximations of the idealized classification-error enumerating objective functions are within the scope of the present invention. As will further be understood by those of ordinary skill in the art, other objective functions that incorporate parameters to control threshold, margin, and slope characteristics of functions that approximate idealized classification-error enumeration are within the scope of the present invention.

Embodiments of the system and method incorporate classification criteria in per-example objective functions that approximate classification-error enumeration. The per-example objective functions may be linearly combined in various ways to form a complete objective function, for instance to tune the relative costs of false negative and false positive classification errors for a given classification task. As will be understood by those of ordinary skill in the art, additional components may be added to the complete objective function to incorporate other objectives in the training process, for instance adding a component to the objective function to encourage further spreading of class centroids. In a training process, gradients of the complete objective function with respect to feature-space transformation model parameters may be backpropagated to update the transformation model parameters so as to improve the classification system performance. In some embodiments, objective function parameters such as threshold and margin parameters may also be updated based on backpropagation in order to refine the classification criteria as part of the training process. As will be understood by those of ordinary skill in the art, such parameter function updates may be carried for each of a number of training iterations to progressively improve the classification system performance.

### Alternate Embodiments and Exemplary Operating Environment

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the deep-learning classifier training system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the system and method described herein, or portions thereof, may be stored, received, transmitted, or read from any desired combination of computer or machine readable media or storage devices and communication media in the form of computer executable instructions or other data structures.

Embodiments of the deep-learning classifier training system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

What is claimed is:

1. A method for training a classification system, comprising:
receiving a batch of labeled examples;
deriving a batch of labeled embeddings at least in part by computing a transformation on each example of the batch of labeled examples;
computing an objective function which at least in part approximates the number of misclassified examples in the batch; and
updating the transformation at least in part based on the computed objective function.

2. The method of claim 1, wherein the objective function is parameterized at least in part by a threshold parameter.
